(19) United States
(12) Patent Application Publication
(10) Pub. No.: US 2024/0329940 A1
(43) Pub. Date: Oct. 3, 2024

(54) SOFTWARE DEVELOPMENT DEVICE AND SOFTWARE DEVELOPMENT PROGRAM

(71) Applicants: Kristopher Andrew TATE, Kyoto-shi, Kyoto (JP); connectFree Corporation, Kyoto-shi, Kyoto (JP)

(72) Inventor: Kristopher Andrew TATE, Kyoto-shi, Kyoto (JP)

(73) Assignees: Kristopher Andrew TATE, Kyoto-shi, Kyoto (JP); connectFree Corporation, Kyoto-shi, Kyoto (JP)

(21) Appl. No.: 18/573,949

(22) PCT Filed: Dec. 12, 2022
(86) PCT No.: PCT/JP2022/045597

§ 371 Date: Dec. 22, 2023

(30) Foreign Application Priority Data
Dec. 14, 2021 (JP) 2021-202788

(51) Int. Cl. G06F 8/30

(52) U.S. Cl. CPC G06F 8/315

(57) ABSTRACT

A software development device for generating software to be executed by a reconfigurable processor includes an analysis module analyzing a source code. A first generation module generates an object code including an instruction code to be given to the processor. A second generation module generates an instruction set architecture setting code defining an instruction set architecture of the processor. An optimization module determines content of the object code and the instruction set architecture setting code on the basis of an analysis result.

### TECHNICAL FIELD

The present disclosure relates to a software development device and a software development program.

### BACKGROUND ART

In the related art, reconfigurable computers or processors have been put into practical use. Techniques for generating software for the computers or the processors have been proposed. For example, JP 2006-155632 A (Patent Document 1) discloses a system that compiles a source code written in, for example, C or Pascal to generate an executable file used by a dynamically reconfigurable processing unit having a selectively replaceable internal hardware structure.

### CITATION LIST

### Patent Document

Patent Document 1: JP 2006-155632 A

### SUMMARY OF THE INVENTION

### Problem to be Solved by the Invention

In the configuration disclosed in Patent Document 1, it is necessary to input a source file including a plurality of instruction statements and a reconfiguration instruction for designating one of hardware structures for a subset of the instruction statements in order to generate an object file to be used by the dynamically reconfigurable processing unit. Therefore, it is only possible to use a predetermined hardware structure, but the entire process is not optimized.

An object of the present disclosure is to provide a new software development technique considering both an instruction set architecture of a processor and an instruction code given to the processor.

### Means for Solving Problem

According to an aspect of the present disclosure, there is provided a software development device for generating software to be executed by a reconfigurable processor. The software development device includes an analysis module analyzing a source code, a first generation module generating an object code including an instruction code to be given to the processor, a second generation module generating an instruction set architecture setting code defining an instruction set architecture of the processor, and an optimization module determining content of the object code and the instruction set architecture setting code on the basis of an analysis result.

The instruction set architecture setting code may include a definition associating a plurality of processes using a wired logic implemented in the processor with a single instruction code.

The instruction set architecture setting code may include a definition of a wired logic to be implemented in the processor.

The optimization module may determine the content of the object code and the instruction set architecture setting code according to the number of repetitions of a specific process included in the source code and complexity of the process.

According to another aspect of the present disclosure, there is provided a software development program for generating software to be executed by a reconfigurable processor. The software development program causes a computer to execute a step of analyzing a source code, a step of generating an object code including an instruction code to be given to the processor, a step of generating an instruction set architecture setting code defining an instruction set architecture of the processor, and a step of determining content of the object code and the instruction set architecture setting code on the basis of an analysis result.

### Effect of the Invention

According to the present disclosure, it is possible to achieve a new software development technique considering both an instruction set architecture of a processor and an instruction code given to the processor.

### BRIEF DESCRIPTION OF DRAWINGS

FIG. 1 is a diagram illustrating a software development device according to the related art;

FIG. 2 is a diagram illustrating a software development device according to this embodiment;

FIG. 3 is a schematic diagram illustrating an example of a hardware configuration of the software development device according to this embodiment;

FIG. 4 is a schematic diagram illustrating an example of a functional configuration of the software development device according to this embodiment;

FIG. 5 is a diagram illustrating a processing example in which the software development device according to this embodiment generates a circuit design code including a microprogram;

FIG. 6 is a diagram illustrating a processing example in which the software development device according to this embodiment generates a circuit design code including a configuration;

FIG. 7 is a schematic diagram illustrating an example of the processing of a source code by the software development device according to this embodiment;

FIG. 8 is a schematic diagram illustrating a processing example of a code generation process of the software development device according to this embodiment; and

FIG. 9 is a flowchart illustrating an example of a processing procedure executed by the software development device according to this embodiment.

### MODE(S) FOR CARRYING OUT THE INVENTION

Embodiments of the present disclosure will be described in detail with reference to the drawings. In addition, the same or equivalent portions in the drawings are designated by the same reference numerals, and a description thereof will not be repeated.

### A. Outline

First, an outline of the present disclosure will be described. The present disclosure is directed to a software development device that generates software to be executed by a reconfigurable processor.

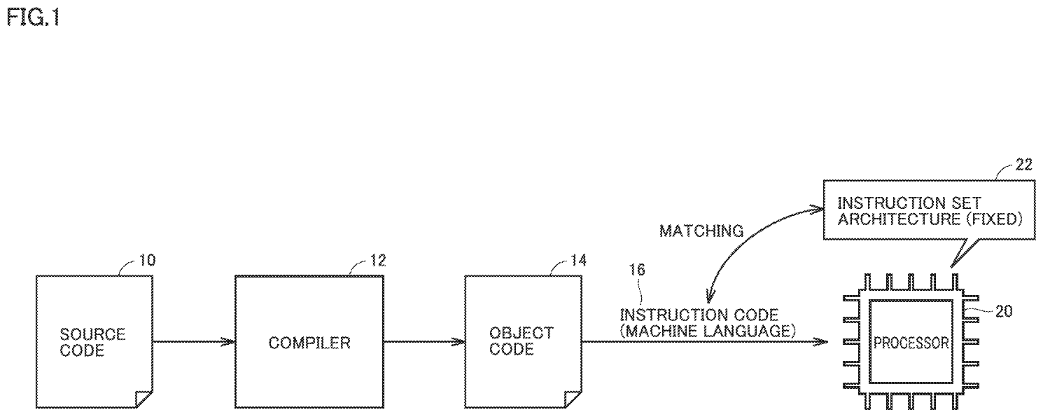

FIG. 1 is a diagram illustrating a software development device according to the related art. FIG. 1 illustrates an example in which a general-purpose processor 20 executes a program.

More specifically, a compiler 12 converts a source code 10, in which a target program has been written, into an object code 14. When the program is executed, instruction codes 16 (written in a machine language) included in the object code 14 are sequentially given to the processor 20.

The processor 20 is composed of a large number of logic circuits, activates a target logic circuit according to the input instruction code 16, and sequentially performs a process corresponding to the instruction code 16. Each of the instruction codes 16 is composed of an operation code for issuing an instruction and an operand for designating a target (if necessary).

An instruction set architecture 22 is designed in the processor 20 in advance. Therefore, the compiler 12 generates the object code 14 so as to be matched with the instruction set architecture 22 in order to cause the processor 20 to perform a process according to the program written in the source code 10.

That is, the instruction code 16 included in the object code 14 is generated according to the rules (instruction set architecture 22) set for the processor 20.

The instruction set architectures are broadly classified into a complex instruction set computer (CISC) and a reduce instruction set computer (RISC). Each system has advantages and disadvantages. When an execution environment is fixed, it is difficult for a user to freely select the instruction set architecture.

The inventor of the present application has discovered a new technical idea that optimizes a combination of an instruction set architecture and an instruction code according to, for example, the content of a program written in a source code to further improve processing performance.

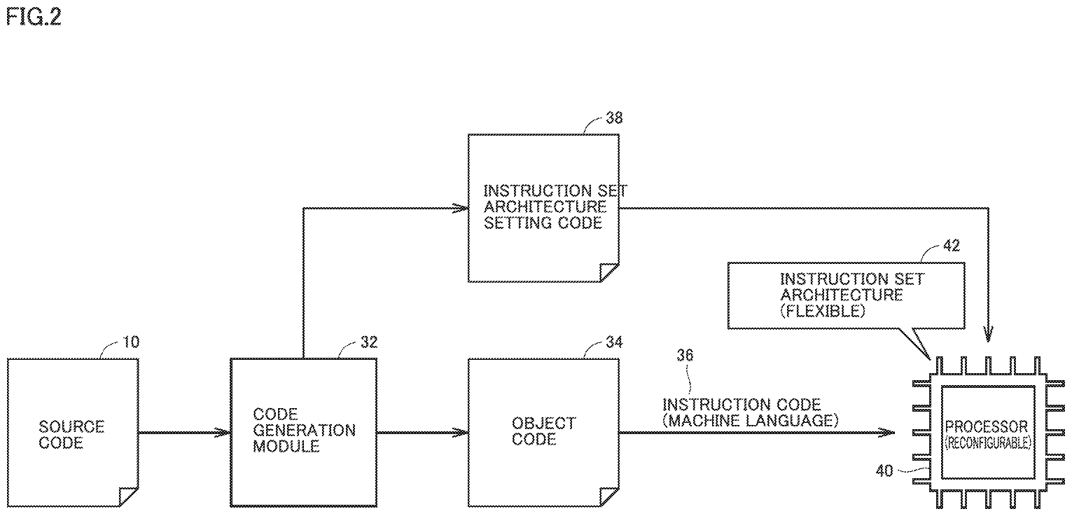

FIG. 2 is a diagram illustrating a software development device according to this embodiment. Referring to FIG. 2, a reconfigurable processor 40 is used in this embodiment. The processor 40 can arbitrarily configure the instruction set architecture.

The following are given as examples of a mechanism for arbitrarily configuring the instruction set architecture: (1) a microprogram implemented in the processor 40 is arbitrarily set; (2) a wired logic (logic circuit) is arbitrarily set; and (3) (1) and (2) are combined.

In the case of (1) in which the microprogram implemented in the processor 40 is arbitrarily set, an interface for updating a microprogram stored in the processor 40 is provided in the processor 40. The microprogram interprets the instruction code and determines, for example, which of the wired logics configured in the processor to use in what order.

In the case of (2) in which the wired logic is arbitrarily set, it is possible to use a field-programmable gate array (FPGA) or a known reconfigurable device.

In this embodiment, a code generation module 32 has a function corresponding to a compiler and generates an object code 34 and an instruction set architecture setting code 38 from the source code 10. When the program is executed, instruction codes 36 (written in a machine language) included in the object code 34 are sequentially given to the processor 40.

The instruction set architecture setting code 38 includes information for setting an instruction set architecture 42 in the processor 40. As described above, in the case of (1) in which the microprogram implemented in the processor 40 is arbitrarily set, the instruction set architecture setting code 38 includes the microprogram. As described above, the instruction set architecture setting code 38 includes a definition that associates a plurality of processes using the wired logic implemented in the processor 40 with a single instruction code.

In addition, in the case of (2) in which the wired logic is arbitrarily set, the instruction set architecture setting code 38 includes information (hereinafter, also referred to as a “configuration”) for configuring the wired logic. As described above, the instruction set architecture setting code 38 includes a definition of the wired logic to be implemented in the processor 40.

Further, in the case of (3) in which (1) and (2) are combined, the instruction set architecture setting code 38 may include both the microprogram and the configuration. The code generation module 32 generates the optimized object code 34 and instruction set architecture setting code 38 according to the program written in the source code 10.

As described above, according to the software development device of this embodiment, it is possible to perform optimization, comprehensively considering the instruction set architecture 42 of the processor 40 and the instruction code 36 output to the processor 40, according to the program written in the source code 10.

### B. Example of Hardware Configuration

Next, an example of a hardware configuration of the software development device according to this embodiment will be described.

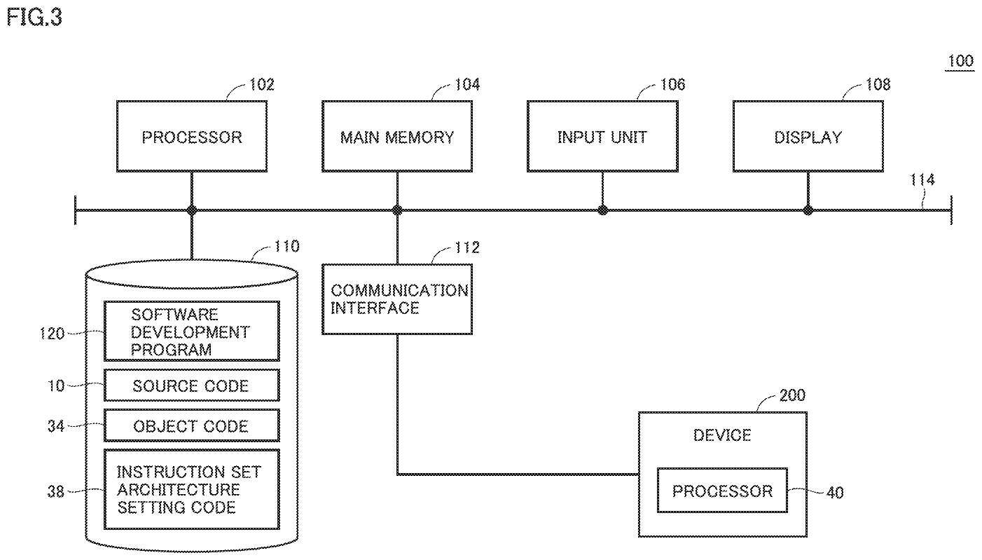

FIG. 3 is a schematic diagram illustrating an example of a hardware configuration of a software development device 100 according to this embodiment. The software development device 100 is typically implemented by a general-purpose computer.

Referring to FIG. 3, the software development device 100 includes, as main components, a processor 102, a main memory 104, an input unit 106, a display 108, a hard disk 110, and a communication interface 112. These components are connected through an internal bus 114.

The processor 102 is configured as, for example, a central processing unit (CPU) or a graphics processing unit (GPU). A plurality of processors 102 may be disposed, or the processor 102 having a plurality of cores may be adopted.

The main memory 104 is configured as a volatile storage device such as a dynamic random access memory (DRAM) or a static random access memory (SRAM). The hard disk 110 stores various programs and various types of data executed by the processor 102. In addition, a non-volatile storage device, such as a solid state drive (SSD) or a flash memory, may be used instead of the hard disk 110. Among the programs stored in the hard disk 110, a designated program is deployed on the main memory 104, and the processor 102 sequentially executes computer-readable instructions included in the program deployed onto the main memory 104 to implement various functions which will be described below.

Typically, the hard disk 110 stores a software development program 120 for achieving an integrated development environment, the source code 10 arbitrarily created by the user, and the object code 34 and the instruction set architecture setting code 38 generated from the source code 10. The software development program 120 generates the object code 34 and the instruction set architecture setting code 38 from the source code 10 arbitrarily created by the user and includes a module that provides a program development environment.

The input unit 106 receives an input operation from the user who operates the software development device 100. The input unit 106 may be, for example, a keyboard, a mouse, a touch panel disposed on a display device, or an operation button disposed on a housing of the software development device 100.

The display 108 displays, for example, a processing result of the processor 102. The display 108 may be, for example, a liquid crystal display (LCD) or an organic electro-luminescence (EL) display.

The communication interface 112 is in charge of exchanging data with a device 200 including the processor 40. The communication interface 112 includes, for example, wired connection terminals, such as a universal serial bus (USB) port, a serial port such as an IEEE1394 port, and a legacy parallel port. Alternatively, the communication interface 112 may include an Ethernet (registered trademark) port.

Furthermore, the communication interface 112 may have a function of writing the microprogram to the processor 40 and/or a function of writing the configuration to the processor 40.

The software development device 100 may further include a component for reading, for example, a stored program from a non-transitory medium that stores the software development program 120 including the computer-readable instructions. The medium may be, for example, an optical medium, such as a digital versatile disc (DVD), or a semiconductor medium, such as a USB memory.

In addition, the software development program 120 may not only be installed in the software development device 100 through the medium, but may also be provided from a distribution server on the network.

### C. Example of Functional Configuration

Next, an example of a functional configuration of the software development device 100 according to this embodiment will be described.

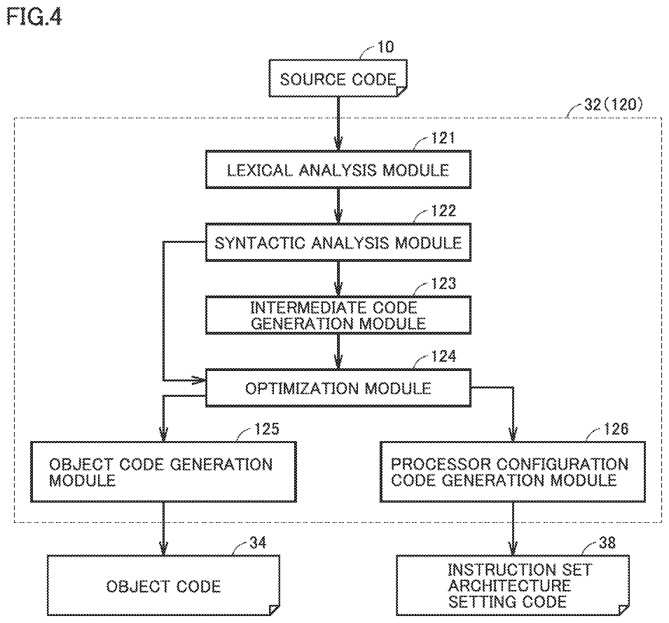

FIG. 4 is a schematic diagram illustrating an example of the functional configuration of the software development device 100 according to this embodiment. Typically, the processor 102 of the software development device 100 may execute the software development program 120 to implement each module illustrated in FIG. 4.

Referring to FIG. 4, the software development device 100 includes a lexical analysis module 121, a syntactic analysis module 122, an intermediate code generation module 123, an optimization module 124, an object code generation module 125, and a processor configuration code generation module 126 as functional components constituting the code generation module 32.

The lexical analysis module 121 and the syntactic analysis module 122 analyze the source code 10.

More specifically, the lexical analysis module 121 analyzes, for example, keywords, identifiers, operators, and delimiters included in the source code 10. The syntactic analysis module 122 determines a syntactic structure included in the source code 10 on the basis of lexical text analyzed by the lexical analysis module 121.

The intermediate code generation module 123 generates an intermediate code in any expression format on the basis of the syntactic structure determined by the syntactic analysis module 122.

The optimization module 124 determines a combination of the instruction set architecture and the instruction code for the processor 40 to perform processes, on the basis of the syntactic structure determined by the syntactic analysis module 122 and the intermediate code generated by the intermediate code generation module 123. Therefore, the optimization module 124 determines the content of the object code 34 and the instruction set architecture setting code 38 on the basis of the analysis results.

The object code generation module 125 generates the object code 34 that can output an instruction code determined from the intermediate code according to the combination determined by the optimization module 124. Therefore, the object code generation module 125 generates the object code 34 including the instruction code to be given to the processor 40.

The processor configuration code generation module 126 generates the instruction set architecture setting code 38 that can implement the determined instruction set architecture according to the instruction set architecture determined by the optimization module 124. Therefore, the processor configuration code generation module 126 generates the instruction set architecture setting code 38 that defines the instruction set architecture of the processor 40.

With the above-described functional configuration, the code generation module 32 (software development program 120) generates the object code 34 and the instruction set architecture setting code 38 from the source code 10.

### D. Processing Examples

Next, an example of a code generation process by the software development device 100 according to this embodiment will be described.

### d1: Processing Example 1

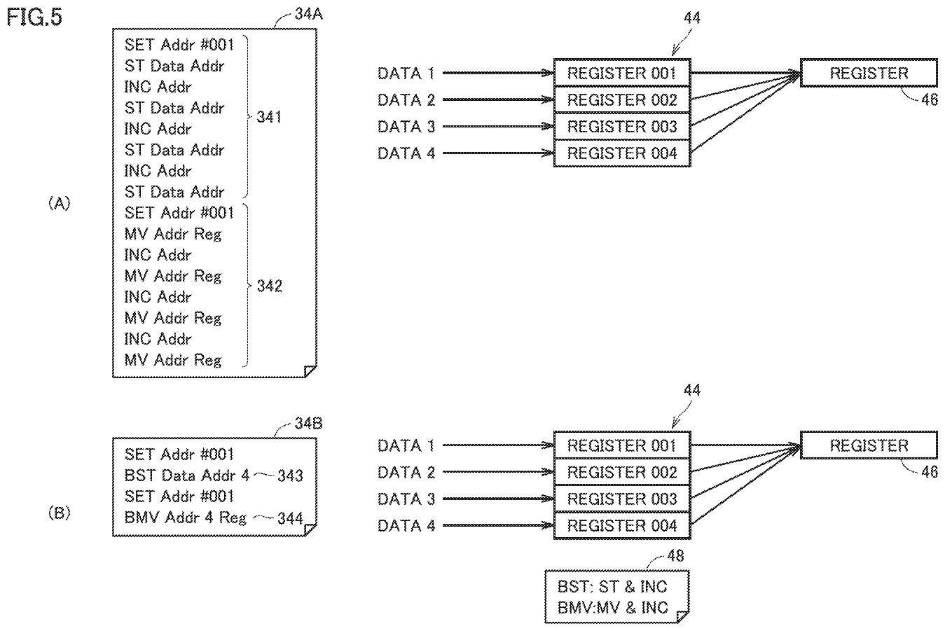

FIG. 5 is a diagram illustrating a processing example in which the software development device 100 according to this embodiment generates the instruction set architecture setting code 38 including a microprogram 48. For example, FIG. 5 illustrates an example in which packets are transmitted from a communication module.

More specifically, FIG. 5 illustrates an example in which data to be transmitted is sequentially written to a register 46 of the communication module. In a memory 44, regions to which addresses 001 to 004 have been given are formed, and data 1 to data 4 are stored in the regions. The data 1 to the data 4 stored in the memory 44 are sequentially transmitted to the register 46. Packets are transmitted from the communication module by this series of processes.

Referring to FIG. 5(A), an object code 34A (for convenience of explanation, similar mnemonic expressions are used (the same applies hereafter)) includes an instruction group 341 for sequentially storing data in the memory 44 and an instruction group 342 for sequentially storing the data stored in the memory 44 in the register 46. As illustrated in FIG. 5(A), substantive information may not be included in the instruction set architecture setting code 38, and the object code 34A may be generated according to the instruction set architecture 42 of the processor 40.

Referring to FIG. 5(B), in a case where it is necessary to repeat the same process a plurality of times, any process may be defined in the microprogram 48. For example, an object code 34B includes a data storage instruction 343 and a data movement instruction 344.

The data storage instruction 343 is written with an instruction code such as “BST Data Addr 4”. Here, the meaning of an operation code “BST” and the format of an operand are written in the microprogram 48. Therefore, the data storage instruction 343 is interpreted with reference to the microprogram 48.

Similarly, the data movement instruction 344 is written in an instruction code such as “BMV Addr 4 Reg”. Here, the meaning of an operation code “BMV” and the format of an operand are written in the microprogram 48. Therefore, the data movement instruction 344 is interpreted with reference to the microprogram 48.

That is, the software development device 100 generates a microprogram in which the meaning of any operation code and the format of the corresponding operand have been written and generates the object code 34 using the operation code written in the generated microprogram.

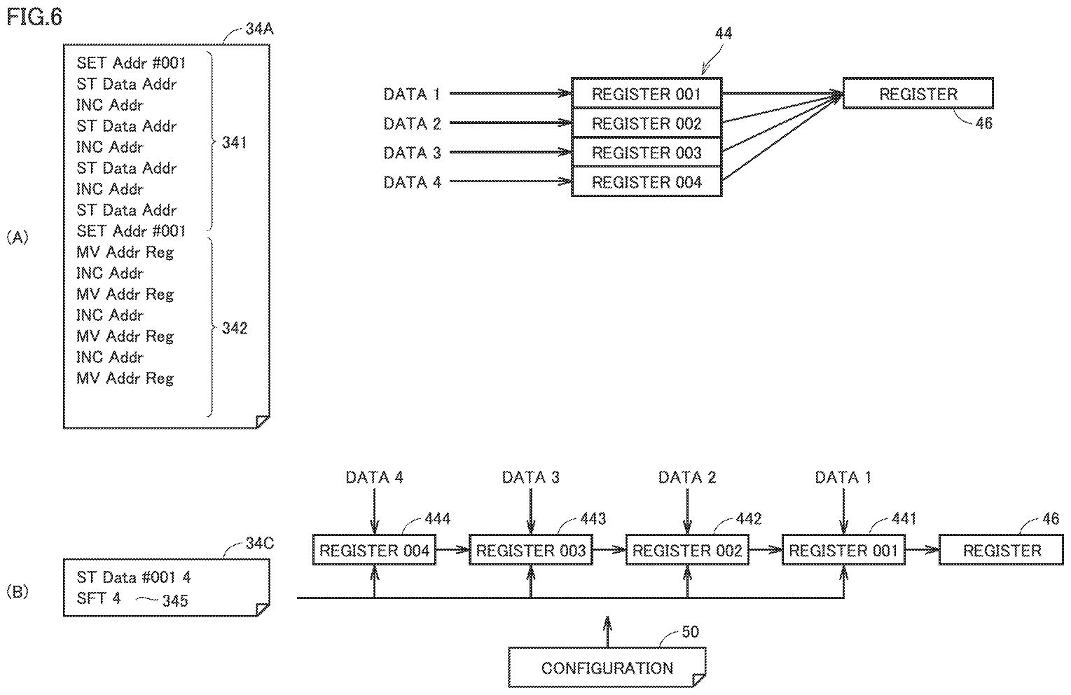

FIG. 6 is a diagram illustrating a processing example in which the software development device 100 according to this embodiment generates the instruction set architecture setting code 38 including a configuration 50. For example, FIG. 6 also illustrates an example in which packets are transmitted from the communication module.

FIG. 6(A) illustrates the same configuration as FIG. 5(A). For the configuration illustrated in FIG. 6(A), a wired logic suitable for the transmission of the packets from the communication module may be adopted as illustrated in FIG. 6(B). More specifically, memories 441 to 444 may be connected in cascade, and input paths for storing data 1 to data 4 in the memories 441 to 444, respectively, may be provided. In addition, a circuit that sequentially moves the data stored in the memories 441 to 444 to adjacent memories may be provided. Therefore, an efficient process can be achieved by configuring the wired logic suitable for the process of transmitting packets from the communication module. Further, the configuration 50 includes information for configuring the wired logic illustrated in FIG. 6(B).

In addition, the configuration of the wired logic illustrated in FIG. 6(B) makes it possible for the object code 34C generated at the same time become a simple code including a transmission instruction 345 for transmitting packets from the communication module. Further, the transmission instruction 345 includes an operation code corresponding to the wired logic configured according to the configuration 50.

Therefore, it is possible to totally optimize the wired logic and the object code and to further improve the processing performance.

Here, as an example of a method for optimizing the combination of the instruction set architecture and the instruction code, the combination of the instruction set architecture and the instruction code may be determined according to the number of repetitions of a specific process included in the source code 10 and the complexity of the process. That is, as the optimization method, the content of the object code and the instruction set architecture setting code may be determined according to the number of repetitions of the specific process included in the source code 10 and the complexity of the process.

Alternatively, among descriptions included in the source code 10, a description that is matched with predetermined rules may be extracted, a corresponding instruction set architecture may be assigned to the extracted description, and an instruction code 36 (written in a machine language) composed of an operation code and an operand that refer to the assigned instruction set architecture may be generated.

### d2: Processing Example 2

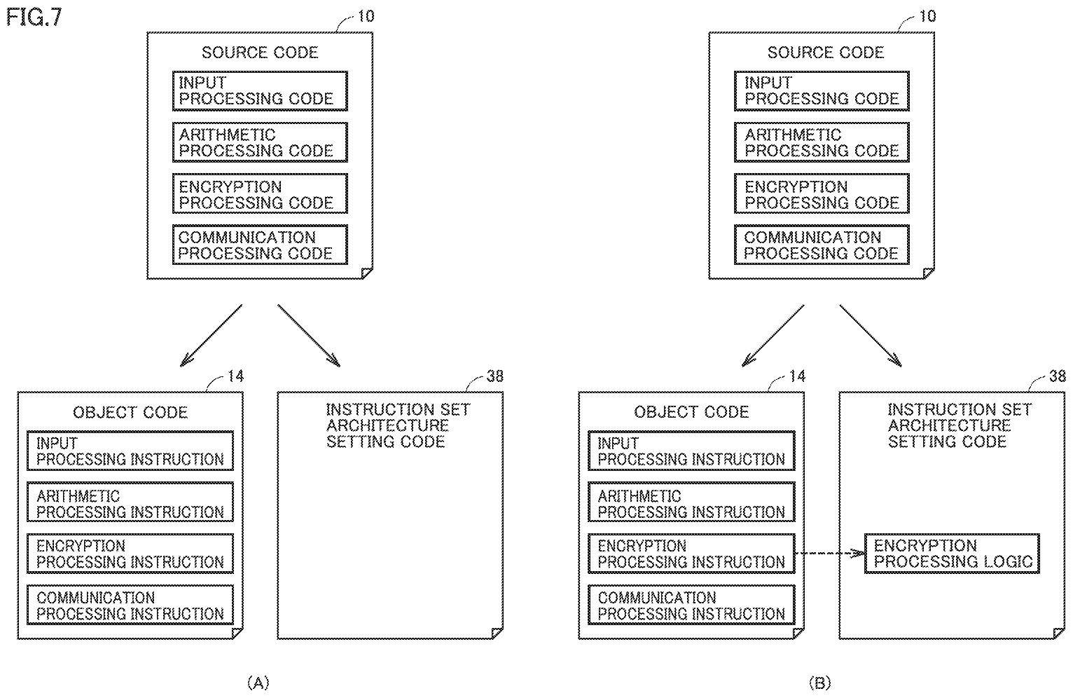

FIG. 7 is a schematic diagram illustrating a processing example of the source code 10 by the software development device 100 according to this embodiment. It is assumed that the source code 10 illustrated in FIG. 7 includes, for example, an input processing code, an arithmetic processing code, an encryption processing code, and a communication processing code. In addition, in the actual source code 10, the processing codes may not be clearly distinguished from each other.

The software development device 100 specifies the process included in the source code 10 using lexical analysis and syntactic analysis and determines which of the object code 34 and the instruction set architecture setting code 38 (the wired logic implemented in the processor 40) is used to implement each process on the basis of, for example, the number of repetitions of the specified process and the complexity of the process.

FIG. 7(A) illustrates an example in which all of the processes written in the source code 10 are implemented in the object code 34. For convenience of explanation, an example in which instructions for implementing each process are individually disposed is given. However, in practice, data in an optimized object format is generated.

FIG. 7(B) illustrates an example in which, among the processes written in the source code 10, processes except an encryption process are implemented in the object code 34. The instruction set architecture setting code 38 includes an encryption processing logic for implementing the encryption process, and the object code 34 is configured to refer to the encryption processing logic defined by the instruction set architecture setting code 38. That is, a wired logic for executing the encryption process is configured in the processor 40 by the instruction set architecture setting code 38. The object code 34 is configured to execute the wired logic configured in the processor 40.

Therefore, the software development device 100 optimizes the content of the object code 34 and the instruction set architecture setting code 38 according to the content of the source code 10.

### d3: Processing Example 3

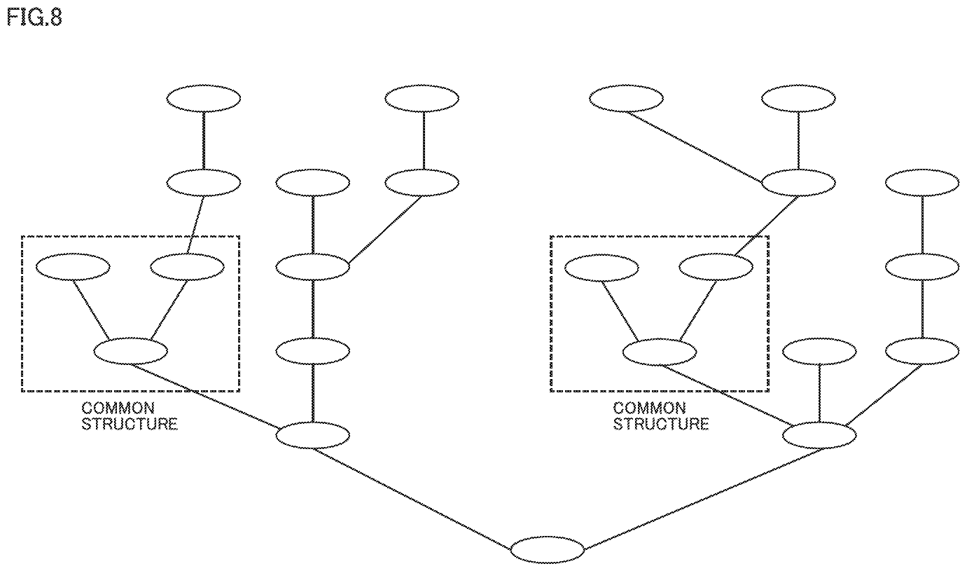

FIG. 8 is a schematic diagram illustrating a processing example of a code generation process of the software development device 100 according to this embodiment. FIG. 8 is a graph illustrating a portion of the intermediate code generated from the source code 10. That is, FIG. 8 illustrates an example of an intermediate representation (IR) corresponding to the intermediate code.

The intermediate representation represents the content of the source code 10 in a format that is independent of that of the object code 34 and the instruction set architecture setting code 38 that is finally generated. For example, the content of the source code 10 may be represented in a tree structure illustrated in FIG. 8 or may be represented by a combination of instruction sequences.

For example, pattern matching or the like is used to extract a partial tree structure that appears repeatedly. The software development device 100 extracts the same or similar portion (hereinafter, also referred to as a “common structure”) from the structures included in the intermediate representation.

When it is determined that it is advantageous to configure the wired logic in the processor 40 according to, for example, the processing content and complexity of the searched common structure, the software development device 100 determines a dedicated logic corresponding to a common structure and adds the dedicated logic as a portion of the instruction set architecture 42 (see FIG. 2).

In addition, a method for extracting the common structure included in the intermediate representation is not limited to the pattern matching and may be a known method using artificial intelligence (AI). Further, any algorithm can be used for the pattern matching.

As described above, the extraction of the same or similar portion from the intermediate code (intermediate representation) makes it possible to reliably perform optimization even in a case where a fluctuation is included in the description of the source code 10 or even in a case where there is a difference in description between program creators or the like. Therefore, it is possible to more efficiently generate the object code 34 and the instruction set architecture setting code 38.

### E. Processing Procedure

Next, an example of a processing procedure executed by the software development device 100 according to this embodiment will be described.

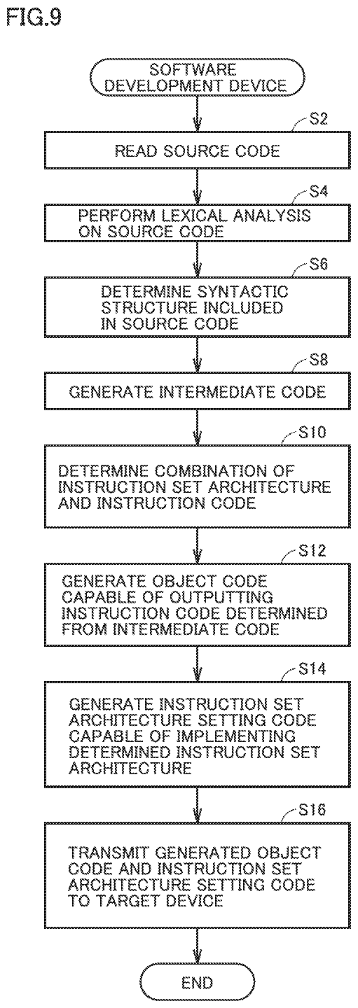

FIG. 9 is a flowchart illustrating an example of the processing procedure executed by the software development device 100 according to this embodiment. Typically, the processor 102 of the software development device 100 may execute the software development program 120 to implement each step illustrated in FIG. 9.

Referring to FIG. 9, the software development device 100 reads the source code 10 in response to an operation of the user (step S2) and performs lexical analysis on the source code 10 (step S4). Then, the software development device 100 determines a syntactic structure included in the source code 10 on the basis of the result of the lexical analysis (step S6) and generates an intermediate code on the basis of the determined syntactic structure (step S8).

The software development device 100 determines a combination of the instruction set architecture and the instruction code on the basis of the result of the lexical analysis and the generated intermediate code (step S10). Then, the software development device 100 generates the object code 34 that can output the instruction code determined from the intermediate code according to the determined combination (step S12). In addition, the software development device 100 generates the instruction set architecture setting code 38 that can implement the determined instruction set architecture according to the determined combination (step S14).

The process related to the generation of a code from the source code 10 is ended in this way.

Finally, the software development device 100 transmits the generated object code 34 and instruction set architecture setting code 38 to the target device 200 in response to the operation of the user (step S16).

### F. Advantages

According to this embodiment, the content of the object code and the instruction set architecture setting code is optimized on the basis of the analysis result of the source code, and then the object code including the instruction code to be given to the processor and the instruction set architecture setting code that defines the instruction set architecture of the processor are generated. The adoption of this configuration makes it possible to achieve a new software development technique considering both the instruction set architecture of the processor and the instruction code to be given to the processor.

The embodiment disclosed here should be considered to be illustrative in all respects and not restrictive. The scope of the invention is indicated by the claims rather than the above description, and it is intended that all changes within the meaning and range equivalent to the claims are included in the invention.

### EXPLANATIONS OF LETTERS OR NUMERALS

10 SOURCE CODE
12 COMPILER
14, 34, 34A, 34B, 34C OBJECT CODE
16, 36 INSTRUCTION CODE
20, 40 PROCESSOR
22, 42 INSTRUCTION SET ARCHITECTURE
32 CODE GENERATION MODULE
38 INSTRUCTION SET ARCHITECTURE SETTING CODE
44, 441 TO 444 MEMORY
46 REGISTER
48 MICROPROGRAM
50 CONFIGURATION
100 SOFTWARE DEVELOPMENT DEVICE
102 PROCESSOR
104 MAIN MEMORY
106 INPUT UNIT
108 DISPLAY
110 HARD DISK
112 COMMUNICATION INTERFACE
114 INTERNAL BUS
120 SOFTWARE DEVELOPMENT PROGRAM
121 LEXICAL ANALYSIS MODULE
122 SYNTACTIC ANALYSIS MODULE
123 INTERMEDIATE CODE GENERATION MODULE
124 OPTIMIZATION MODULE
125 OBJECT CODE GENERATION MODULE
126 PROCESSOR CONFIGURATION CODE GENERATION MODULE
200 DEVICE
341, 342 INSTRUCTION GROUP
343 DATA STORAGE INSTRUCTION
344 DATA MOVEMENT INSTRUCTION
345 TRANSMISSION INSTRUCTION

1. A software development device for generating software to be executed by a reconfigurable processor, the software development device comprising:
an analysis module analyzing a source code;
a first generation module generating an object code including an instruction code to be given to the processor;
a second generation module generating an instruction set architecture setting code defining an instruction set architecture of the processor; and
an optimization module determining content of the object code and the instruction set architecture setting code based on an analysis result.

2. The software development device according to claim 1,
wherein the instruction set architecture setting code includes a definition associating a plurality of processes using a wired logic implemented in the processor with a single instruction code.

3. The software development device according to claim 1,
wherein the instruction set architecture setting code includes a definition of a wired logic to be implemented in the processor.

4. The software development device according to claim 1,
wherein the optimization module determines the content of the object code and the instruction set architecture setting code according to the number of repetitions of a specific process included in the source code and complexity of the process.

5. A non-transitory storage medium storing thereon a software development program for generating software to be executed by a reconfigurable processor, the software development program causing a computer to execute:
a step of analyzing a source code;
a step of generating an object code including an instruction code to be given to the processor,
a step of generating an instruction set architecture setting code defining an instruction set architecture of the processor, and
a step of determining content of the object code and the instruction set architecture setting code based on an analysis result.
